(19) United States
(12) Patent Application Publication
(10) Pub. No.: US 2010/0032179 A1
(43) Pub. Date: Feb. 11, 2010

(54) POWER TOOL WITH EXCHANGEABLE REDUCTION GEARING UNIT

(75) Inventors: Jan Thomas Hanspers, Bromma (SE); Erik Mikael Monsell, Huddinge (SE)

Correspondence Address: FRISHAUF, HOLTZ, GOODMAN & CHICK, PC, 220 Fifth Avenue, 16TH Floor, NEW YORK, NY, 10001-7708, US

(73) Assignee: ATLAS COPCO TOOLS AB, Nacka (SE)

(21) Appl. No.: 12/513,825

(22) PCT Filed: Nov. 8, 2007
(86) PCT No.: PCT/SE2007/000988

§ 371 Date: May 6, 2009

(30) Foreign Application Priority Data
Nov. 8, 2006 (SE) 0602364-2

(51) Int. Cl. B23Q 5/54

(52) U.S. Cl. 173/11

(57) ABSTRACT

A power tool includes a power unit with a rotation motor, and a reduction gearing, wherein the reduction gearing includes a set of interchangeable gearing units attachable one at a time to the power unit and having different operational characteristics including different total gear ratio and torque capacity. Each gearing unit has an electronic identification device programmed with data specific for each gearing unit, such as total gear ratio, torque range, and relating to compatibility of the gearing unit with a certain power unit. The power unit includes an electronic operation control unit programmed with a number of different operation parameter sets each intended for a specific one of the gearing units, and a circuit for communicating with a gearing unit attached to the power unit to determine whether there is compatibility and which parameter set is applicable.

The invention relates to a power tool having a power unit, a reduction gearing, and an output shaft.

A problem concerned with a power tool of the above type is the limited field of use due to the specific output speed and torque level determined by the total gear ratio of the reduction gearing. When at a working station there is a need for tools with a number of different output torque levels and/or speed levels for performing a number of different working operations a number of tools with different reduction gearings have to be used. This means that a rather costly arsenal of power tools has to be provided.

It is the main object of the invention to provide a power tool of the above type which will be more versatile and reduce substantially the number of power tools needed for performing different working operations at a working station.

Another object of the invention is to provide a power tool of the above type wherein the operational characteristics of the reduction gearing may be obtained.

A preferred embodiment of the invention is described below in detail with reference to the accompanying drawing.

### IN THE DRAWINGS

FIG. 1 shows a side view of a power tool according to the invention and illustrates schematically three different reduction gearing units attachable to the power unit.

FIG. 2A shows a fractional side view of the power tool in FIG. 1 with a reduction gearing unit attached to the power unit.

FIG. 2B shows a cross section through the interface between the reduction gearing unit and the power unit with a retaining means in a locked position.

FIG. 3A shows the same tool as in FIG. 2A but illustrates the reduction gearing unit being removed from the power unit.

FIG. 3B shows a cross section similar to that of FIG. 2B but illustrates the retaining means in a released position.

FIG. 4 shows a longitudinal section through a reduction gearing unit according to the invention.

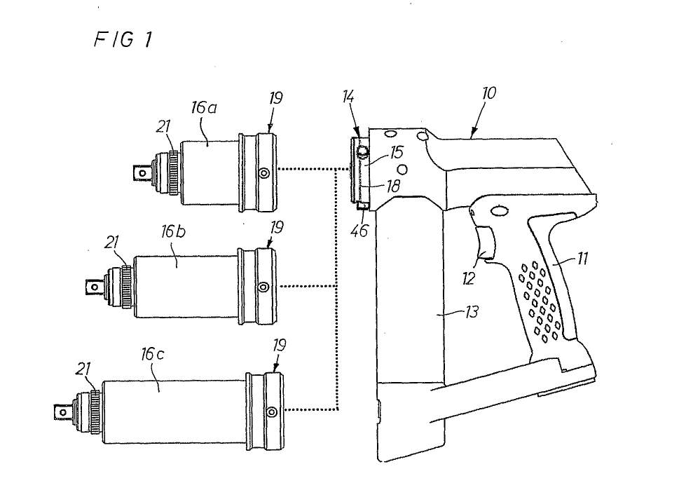

The power tool shown in FIG. 1 comprises a power unit 10 including a handle 11 with a power control push button 12, and a motor section 13 including a non-illustrated rotation motor. The motor is coupled to a drive spindle via an angle drive. This is of no significance to the present invention and is therefore not illustrated in detail. The drive power unit 10 further comprises a docking means 14 for attachment of separate reduction gearing units 16a-c supporting output shafts. The docking means 14 comprises a tubular neck portion 15 extending co-axially with the gearing unit 16a-c to be attached to the power unit 10. The neck 15 is provided with a circumferential groove 18 forming part of a retaining means for the gearing units 16a-c. A reduction gearing unit suitable for a certain working operation is chosen from a number of interchangeable gearing units 16a-c of different characteristics as to the total gear ratio, torque output and speed. Each gearing unit 16a-c has an output shaft to be connected to for instance a nut socket for screw joint tightening.

This type of power tool is specifically suitable for heavy duty screw joint tightening, i.e. tightening rather big screw joints to high torque levels, and in order to take up and protect the operator form the heavy reaction torque developed during tightening of a screw joint the separate reduction gearing unit is rotatable relative to the power unit 10 and fitted with a reaction bar (not illustrated). Such reaction bar is intended to take support against a stationary object close to the screw joint being tightened, and each gearing unit is provided with a splined portion 21 for mounting of such a reaction bar.

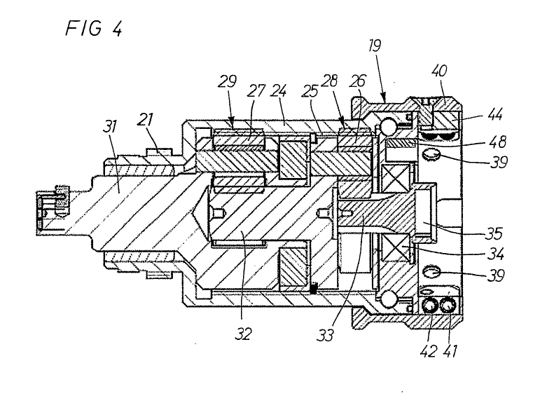

Each gearing unit 16a-c has a connection portion 19 to form a swivel connection with the docking means 14 of the power unit 10. As illustrated in FIG. 4 each one of the gearing units comprises a cylindrical casing 24 with ring gear teeth 25 on its inside for co-operation with planet wheels 26,27 of a first planetary gearing 28 and a second planetary gearing 29, respectively. At its forward end the casing 24 supports an output shaft 31 which forms a planet wheel carrier for the second gearing 29, whereas the sun gear 32 of the second gearing 29 forms the planet wheel carrier for the first gearing 28. The sun gear 33 of the first gearing 28 is supported in a bearing 34 and is formed with a polygonal socket portion 35 for interconnection with a non-illustrated drive spindle in the power unit 10.

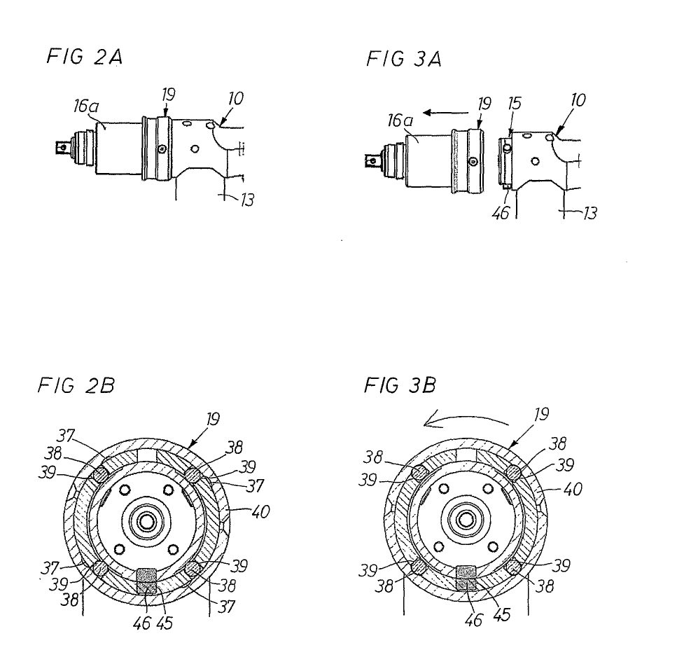

The connection portion 19 located at the rear end of each gearing unit 16a-c includes the retaining means in the form of four balls 38 supported in apertures 39 in the rear end of the casing 24, and a lock ring 40 rotatable on the outside of the casing 24 between a lock position and a release position. The lock ring 40 is formed with four pockets 37 for partly receiving the balls 38 in the release position of the lock ring 40. In the lock position of the lock ring 40 the balls 38 are radially locked in engagement with the circumferential groove 18 on the power unit neck portion 15. In FIG. 2B the lock ring 40 occupies its lock position, whereas FIG. 3B illustrates the lock ring 40 in the release position with the balls 38 received in the pockets 37 and disengaged with the groove 18 on the neck 15 on the power unit 10. In its release position the lock ring 40 has been rotated in the direction of the arrow in FIG. 3B.

Two toroid shaped springs 41,42 are located inside the lock ring 40 and take support on one hand against a non-illustrated shoulder in the casing and on the other hand against a dog element 44 mounted on the lock ring 40 so as to bias the lock ring 40 towards its lock position. At its rear end each gear unit casing 24 is provided with a pocket 45 to receive an anti-rotation stud 46 on the power unit 10. The purpose of this stud 46 is to prevent rotation of the gearing unit when rotating the lock ring 40 between the lock and release positions.

Each one of the gearing units 16a-c is provided with an electronic identification device 48 by which the identity of each gearing unit is recognizable, including the operation characteristics like the total gear ratio and torque range, and the compatibility with a certain power unit etc. Preferably, this electronic identification device 48 also includes means for registering data like the number of working operations performed which enables the actual status of the gearing unit and the service need to be estimated. The identification device 48 may very well be a programmed data chip.

The information provided by the identification device 48 is received by an electronic operation control means onboard the power unit 10. This control means is programmed with a certain number of alternative parameter sets for performing working operations with either one of a number of gearing units, each parameter set is suitable for one particular gearing unit and a specific working operation. For instance in screw joint tightening applications the parameter sets comprise desired torque level and angle of rotation to perform a tightening operation in a correct way.

When a specific one of the available gearing units 16a-c is attached to the power unit 10 the operation control means onboard the power unit 10 emits signals in the form of probe cycles searching for a response signal from the gearing unit, and when the specific response signal from the attached gearing unit is received the operation control means firstly decides whether that gearing unit is in fact compatible with the power unit. If compatibility is correct then the control means matches the received signal with a specific parameter set suitable for this very gearing unit. When compatibility is established and the correct operation parameter set is chosen the operation control means puts the power tool into operable condition.

As described above, the identification device may also include means for registering the number of performed working cycles of the gearing unit and perhaps also the torque load transferred during performed operations. This makes it possible to estimate the present status of the gearing unit. This can be done by docking the gearing unit with a stationary test device which comprises electronic means which is able to communicate with the identification device 48 on the gearing unit and to retrieve data therefrom.

1. A power tool comprising:
a power unit, and a reduction gearing with an output shaft,
wherein the reduction gearing is one of a set of interchangeable reduction gearing units of different operational characteristics and attachable to the power unit one at a time, wherein each one of said gearing units is provided with an electronic identification device programmed with data specific for that gearing unit, including total gear ratio, torque range, and to which type of power unit it is compatible.

2. The power tool according to claim 1, wherein said identification device comprises a data chip.

3. The power tool according to claim 1, wherein said identification device of each one of said gearing units comprises means for registering and accumulating a number of performed working cycles.

4. The power tool according to claim 1, wherein the power unit comprises:
an electronic operation control unit programmed with a number of different operation parameter sets each one intended for a specific one of said gearing units, wherein said operation control unit comprises a circuit which enables communication with the identification device of the gearing unit attached to the power unit for establishing compatibility of the gearing unit and the power unit and for choosing the parameter set intended for that gearing unit.

5. The power tool according to claim 2, wherein said identification device of each one of said gearing units comprises means for registering and accumulating a number of performed working cycles.

6. The power tool according to claim 2, wherein the power unit comprises:
an electronic operation control unit programmed with a number of different operation parameter sets each one intended for a specific one of said gearing units, wherein said operation control unit comprises a circuit which enables communication with the identification device of the gearing unit attached to the power unit for establishing compatibility of the gearing unit and the power unit and for choosing the parameter set intended for that gearing unit.

7. The power tool according to claim 3, wherein the power unit comprises:
an electronic operation control unit programmed with a number of different operation parameter sets each one intended for a specific one of said gearing units, wherein said operation control unit comprises a circuit which enables communication with the identification device of the gearing unit attached to the power unit for establishing compatibility of the gearing unit and the power unit and for choosing the parameter set intended for that gearing unit.

8. The power tool according to claim 5, wherein the power unit comprises:
an electronic operation control unit programmed with a number of different operation parameter sets each one intended for a specific one of said gearing units, wherein said operation control unit comprises a circuit which enables communication with the identification device of the gearing unit attached to the power unit for establishing compatibility of the gearing unit and the power unit and for choosing the parameter set intended for that gearing unit.
